(19) United States
(12) Patent Application Publication
(10) Pub. No.: US 2019/0093280 A1
(43) Pub. Date: Mar. 28, 2019

(54) PROCESS FOR PROVIDING WATER REPELLENCY

(71) Applicant: HEIQ PTY LTD, Waurn Ponds, Victoria (AU)

(72) Inventors: Alessandra SUTTI, Torquay, Victoria (AU); Murray HEIGHT, Newtown, Victoria (AU); Mark KIRKLAND, Batesford, Victoria (AU); Marzieh PARHIZKAR, Marshall, Victoria (AU); Danielle BASSANESE, Belmont, Victoria (AU); Teo SLEZAK, Belmont, Victoria (AU); Kiran Annaso PATIL, Grovedale, Victoria (AU); Rongliang HE, Waurn Ponds, Victoria (AU); Kevin MAGNIEZ, Clifton Springs, Victoria (AU); Paul COLLINS, Armstrong Creek, Victoria (AU)

(21) Appl. No.: 15/766,651

(22) PCT Filed: Oct. 13, 2016
(86) PCT No.: PCT/AU2016/050958

§ 371 Date: Apr. 6, 2018

(30) Foreign Application Priority Data
Oct. 14, 2015 (AU) 2015904197

(51) Int. Cl. D06M 23/08; D06M 23/14; B01J 2/30; B01J 2/06

(52) U.S. Cl. CPC D06M 23/08; D06M 23/14; D06M 2400/01; B01J 2/06; D06M 2200/12; B01J 2/30

(57) ABSTRACT

A process for providing a water repellent substrate comprising: providing a dispersion in a liquid of discrete-length microfibers comprising a material adapted to be fluid under the processing conditions to be used; applying the dispersion to the substrate; optionally removing liquid from the microfibers and substrate or allowing the liquid to dry; and subjecting the microfibers to processing conditions under which the material is at least partly fluid, such that the microfibers deform to provide adhesion of microfibers with other microfibers, adhesion of the microfibers with the substrate or a mixture of adhesion with other microfibers and with the substrate.

This application is a national stage application under 35 U.S.C. § 371 of PCT Application No. PCT/AU2016/050958, filed Oct. 13, 2016, which claims the priority benefit of Australia Patent Application No. 2015904197, filed Oct. 14, 2015.

### TECHNICAL FIELD

The invention relates to a method of providing a water repellent substrate and to a water repellent substrate provided by the method. More particularly the invention relates to providing water repellence which is durable.

### BACKGROUND OF INVENTION

Substrates that possess water repellency are desirable in many fabric and textile applications, and have been manufactured for some time. Other types of substrates including paper, packaging and cardboard are advantageously rendered water repellent in many applications. Water repellency generally means the ability of the substrate to block water from penetrating into the depth of the substrate. In the case of fabric this will inhibit water occupying inter-fiber spaces, as well as from penetrating into the fibers themselves where the fibers have inherent porosity. Hydrophilic stains can be prevented by means of water repellency. Examples of textiles in which water repellency is important include clothing such as rain resistant outdoor wear, upholstery applications, carpet and textiles used outdoors including awnings and sunshades.

Water repellency is conventionally conferred on fabric articles by applying suitable perfluorinated chemicals (PFCs) to the surface of the fabric. Certain categories of perfluorinated compounds (e.g. PFOA and PFOS) are persistent in the environment and in human tissue and there is therefore a need to provide methods for providing the water repellency which allow reduced use of fluorocarbon substances. The C8 fluorocarbon chemistry (the most highly performing product form) is being phased out by regulations due to environmentally persistent residues that are particularly serious for C8-based PFCs. The C6 and C4 products are entering the market to fill the gap however they are not as effective as C8 and are generally more expensive. Fluorine-free treatments are growing in importance as they completely avoid any concerns over fluorine-related residues however their performance currently lags behind fluorine-based treatments. There is a need to raise the performance of fluorine-free treatments to allow reduction in the use of fluorine products or their complete replacement.

Alternative options for obtaining water repellency often do not provide the required durability and water repellancy is lost with time due to laundering or wear. For example the need to reduce PFC use has resulted in a return to the use of paraffin (wax) treatments but the durability of waxes to repeated washing is relatively poor. Polymer dendrimers have also been used but are relatively expensive to manufacture. Particulate minerals (e.g. silicon dioxide) have also been examined as a way to increase water repellency as individual substances or in combination with conventional repellency treatments.

There remains a need for alternative methods for providing durable water repellency, which allows the use of PFCs to be reduced.

### SUMMARY OF THE INVENTION

We have found that the application of certain microfiber dispersions and treatments allows the surface of a substrate to be modified by adhesion of the microfibers to provide durable water repellency.

Accordingly we provide a process for providing a water repellent substrate comprising:

providing a dispersion in a liquid of discrete-length microfibers comprising a material adapted to be fluid under processing conditions to be used;

applying the dispersion to the substrate;

optionally removing liquid from the microfibers and substrate or allowing the liquid to dry; and

subjecting the microfibers to processing conditions under which the material is at least partly fluid such that the microfibers deform and provide adhesion of microfibers with other microfibers, adhesion of the microfibers with the substrate or a mixture of adhesion with other microfibers and with the substrate.

There is further provided, in one set of embodiments, a process for providing water repellent substrate comprising:

providing a dispersion in a liquid of discrete-length microfibers comprising a solid material at least a portion of which has a softening point of no more than 160° C.;

applying the dispersion to the substrate;

removing liquid from the fibers and substrate; and

heating the microfibers at a temperature in the range of from 110° C. to 180° C., and at which the solid material is at least partly fluid, such that the microfibers deform to provide adhesion of microfibers with other microfibers, adhesion of the microfibers with the substrate or a mixture of adhesion with other microfibers and with the substrate.

In a further set of embodiments there is provided a fabric comprising fibers and microfibres adhered to the surface of the fibers. The microfibers are preferable adhered by the above described process.

In a further set of embodiments there is provided a water repellent substrate comprising microfibers adhered to the substrate by softening and deformation of the microfibers on the substrate surface.

### BRIEF DESCRIPTION OF DRAWINGS

FIG. 1 is a photograph under magnification showing a microfiber composition comprising PEAA and amorphous fumed silica 5% wt/wt of polymer. The image is 680 micron wide.

FIG. 2 is an electron micrograph view of a polyamide-elastane fabric which has been treated in accordance with Example 83. (The scale bar shows 100 microns).

FIG. 3 is a higher magnification electron micrograph view of a polyamide-elastane fabric which has been treated in accordance with Example 83. (The scale bar shows 10 microns).

FIG. 4 is a graph showing the improvement in water contact angle when Primacor (59901) fibres (with and without silica) is added to ECO/SAX treatments. The samples were prepared in accordance with Comparative Example CE1, and Examples 6, 89, 95, 101. (The graph showing groups of treatments include three columns in each group which from left to right are: fibre only (no heat), fibers only (heat) and fibres+HeiQ Barrier ECO/HeiQ Effect SAX)

FIG. 5 is an electron micrograph view of a polyamide-elastane fabric which has been treated in accordance with Example 8 (after 10 heavy wash cycles). (The scale bar shows 20 microns).

FIG. 6 is an electron micrograph view of the fibre surface of a polyamide-elastane fabric which has been treated in accordance with Example 15 (A) and Example 29 (B). The surface features which are visible range in height (in a direction normal to the surface) from no less than 0.01 microns to above 5 microns (for those samples that show little or no deformation upon heating), and with aspect ratio above 2. (The scale bar shows 10 microns).

FIG. 7 is a graph showing the AATCC22 spray-test performance for fabrics treated according to Examples 1-15 and Comparative Examples CE1-7.

FIG. 8 is a graph showing the AATCC22 spray-test performance for fabrics treated according to Examples 30-49 and Comparative Examples CE1-7.

FIG. 9 is a graph showing the AATCC22 spray-test performance for fabrics treated according to Examples 30-49 and Comparative Examples CE1-7 after 10 heavy wash cycles.

FIG. 10 is a graph showing the AATCC22 spray-test performance for fabrics treated according to Examples 152-166 and Comparative Examples CE4-6.

FIG. 11 is a graph showing the AATCC22 spray-test performance for fabrics treated according to Examples 152-166 and Comparative Examples CE4-67 after 10 heavy wash cycles.

FIG. 12 is a graph showing the AATCC22 spray-test performance for fabrics treated according to Examples 70-77 and Comparative Examples CE1-7.

FIG. 13 is an electron micrograph of a cotton fabric coated according to Example 167. (The scale bar shows 10 microns).

FIG. 14 are two electron micrographs of a polyester fabric according to Examples 147 (A) and 151 (B). Electron microscopy image: polyester fabric, coated with HM-C6 3% w (left) and HM-C6 0.25% wt (right), and containing fibers made from a silk-PEAA blend—high coverage. (The scale bar shows 10 microns).

FIG. 15 are high magnification photos illustrating the highly-hydrophobic sticky effect provided to the fabric in Example 180, with 5 μl of water deposited on a fabric constituted of microfibres made of a 50:50 w blend of silk-fibroin and Primacor 59901 (images at different magnification). The drop is sitting on the fabric at: A) 0° tilt (i.e. horizontal) showing high water contact angle, B) around 15° tilt, C) >90° tilt, showing water contact angle hysteresis, and D) 180°. The droplet remains pinned (sticky hydrophobic) to the fabric upon tilting by 180°.

FIG. 16 are high magnification photos illustrating the highly-hydrophobic sticky effect, with 5 μl of water deposited on a fabric constituted of microfibres made of Primacor 59901 (images at different magnification). The drop is sitting on the fabric at: A) 0° tilt showing high water contact angle, and B) 90° tilt. The droplet remains pinned (sticky hydrophobic) to the fabric upon tilting by 90°.

FIG. 17 is a high magnification photograph of the treated fabric of Example 127. (The scale bar shows 10 microns).

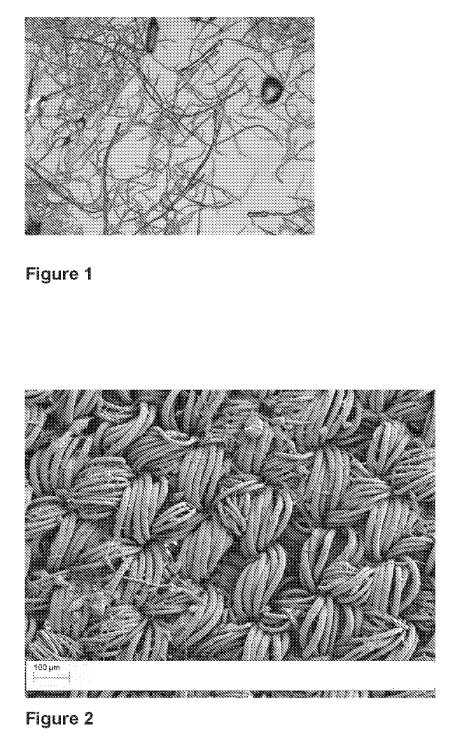

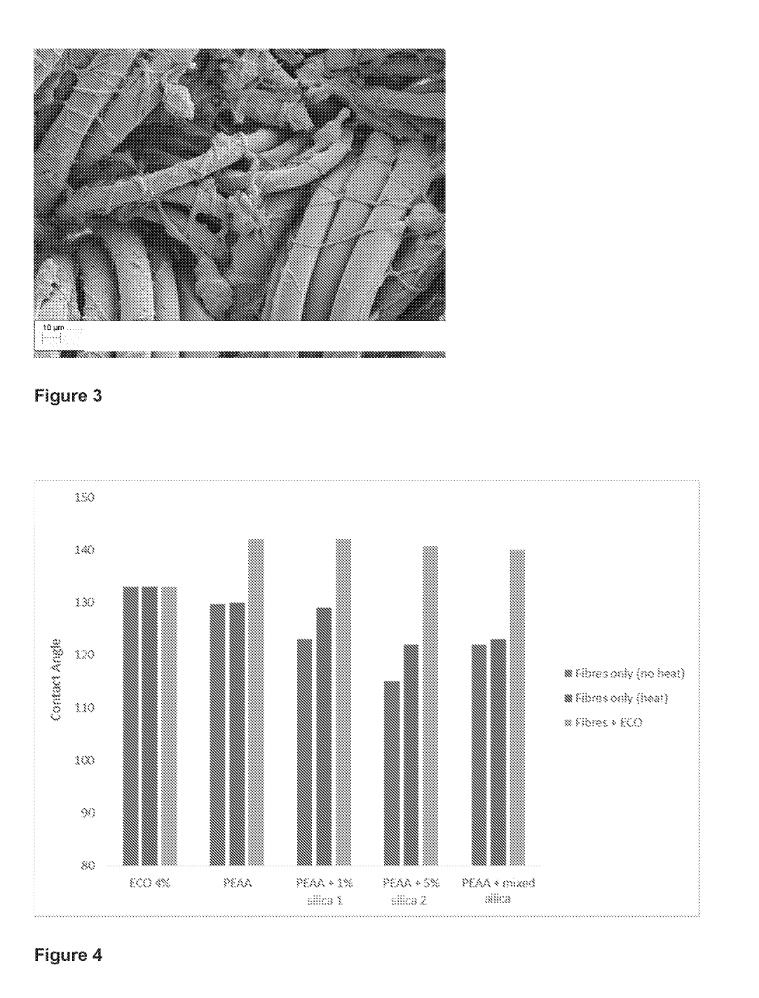

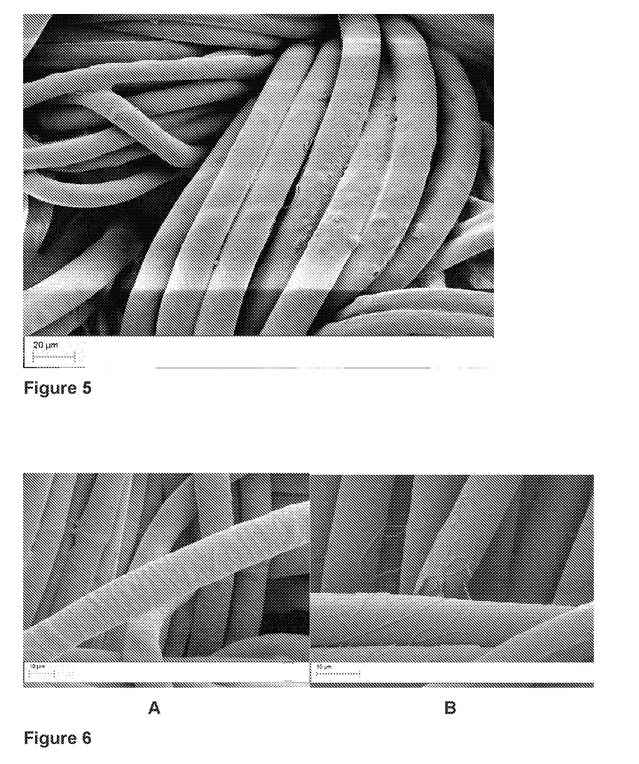

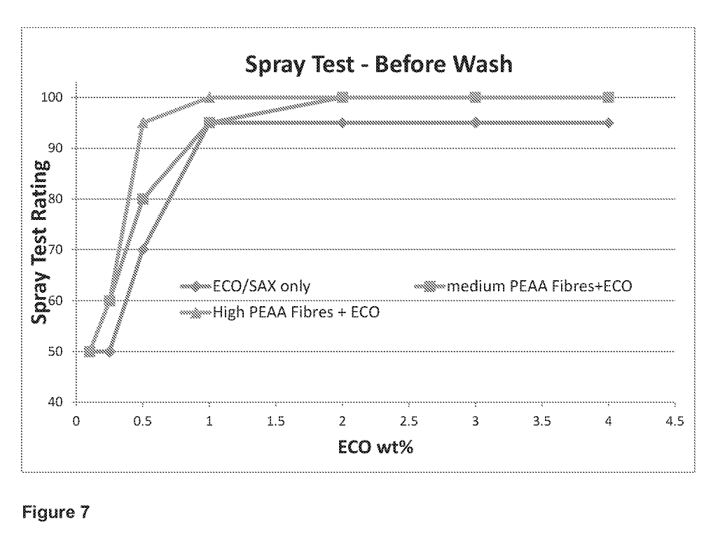

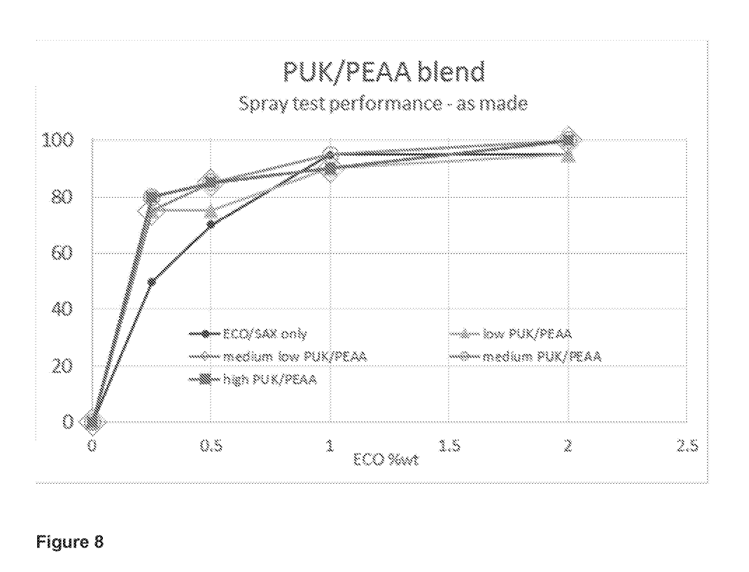

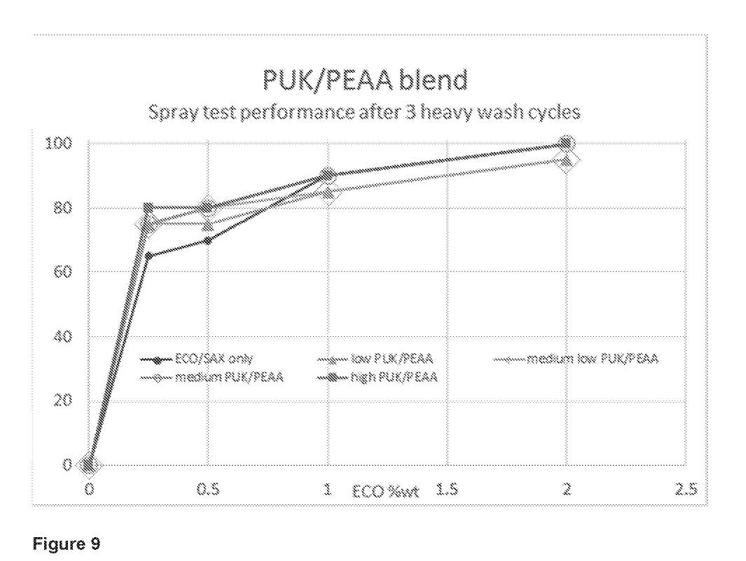

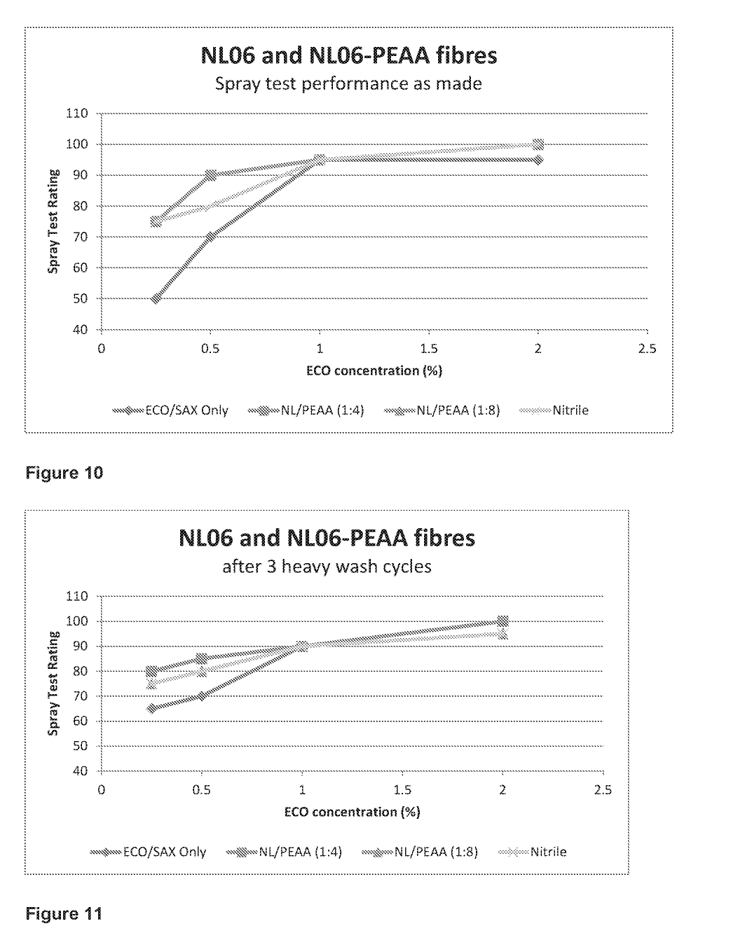

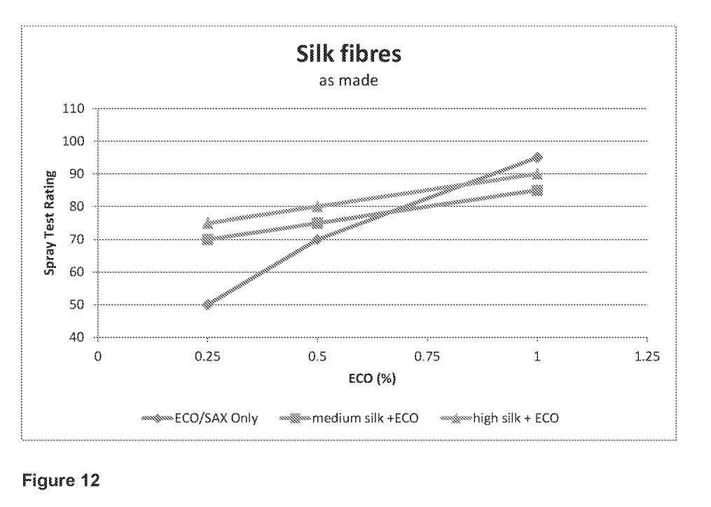

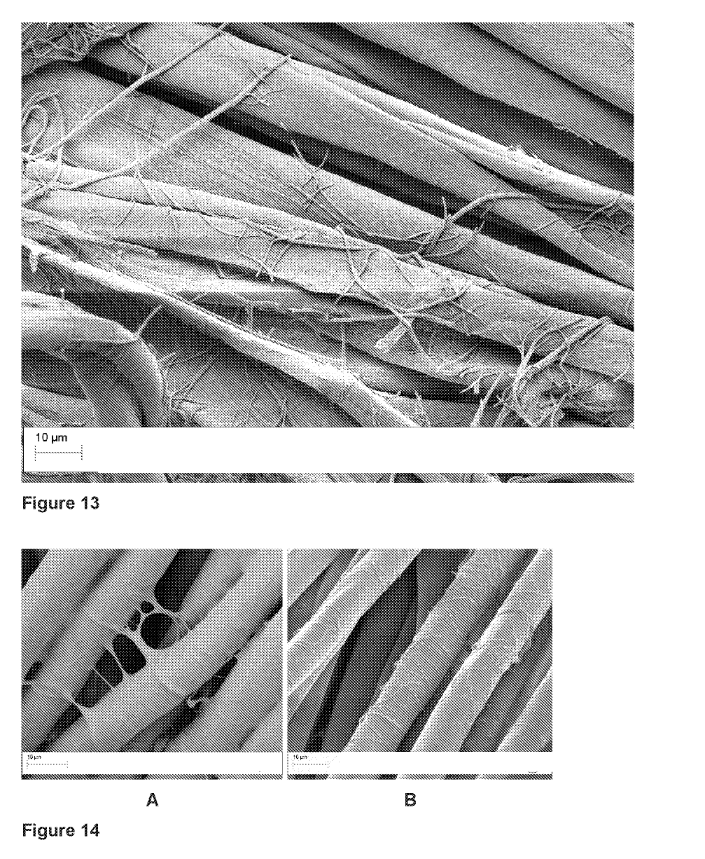

### DETAILED DESCRIPTION

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

Where used herein the terms “discrete length microfiber” and “microfiber” refer to a fiber structure having a dimension in the range of from 5 to 1000 microns average length and from 0.01 to 5 microns average thickness, preferably 5 to 300 microns average length and 0.1 to 3 microns average thickness. In one set of embodiments the aspect ratio (length/thickness) of the microfibers is at least 10:1 preferably at least 50:1.

The terms “deform” and “deformation” in relation to the microfibers encompasses the distortion of a shape such that the geometry of the perimeter of the shape changes. The deformation of a shape may be from generally round cross section or cylindrical to a shape which includes a surface which conforms to the shape of the substrate surface. By way of example, a round cross section may deform out-of-round to form an ellipse which may be flattened or convex to conform to the shape of a flat or convex portion of a substrate such as on the surface of a fibrous substrate (e.g. Fabric). In general deformed microfibers will retain a generally fibrous morphology adhered on a portion along the length of the microfiber to the substrate surface. The adhered microfibers may be observed using, for example, scanning electron microscopy. The deformation of microfibers results in an increase in the contact area between the microfibers and substrate which significantly enhances the durability of the change produced by the microfibers.

As used herein, the terms “polymer” and “polymeric material” generally include homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

The term “softening point” means the temperature at which the material passes from a solid to a fluid state. In the case of polymeric materials in amorphous polymers, the softening point corresponds to the glass transition point (Tg), and in (partially) crystallized polymers, it corresponds to the melting point.

“Solvent” in relation to a particular solid material such as a polymer means a liquid which, when contacted with that solid material, optionally after the microfiber comprising the solid material is formed, partially dissolves, or at least substantially swells, that polymer without being permanently bonded to or incorporated into the polymer.

The terms “tilt” and “roll-off angle” with reference to water run-off and “water pinning” refer to the angle from horizontal so that at an angle of 90° the substrate or treated substrate is vertical (perpendicular to the horizontal plane).

As used herein, the term “morphology” and “microfiber morphology” refers to the general external structure of a microfiber being apparent on the surface of the substrate. The microfibers comprise a solid component, which is caused to flow and adhere during the process, but the microfibers remain identifiable as features on the substrate. Thus while being rendered fluid to some extent the extent of flow is not such as to completely spread so that the morphology of a microfiber is completely lost. The microfiber morphology may be observed under scanning electron microscope and may appear as microfibers having a deformed cross section and adhered along a portion of their length to other microfibers or to the substrate. In embodiments where the substrate is fibrous the microfibers typically have an average maximum cross section dimension in the adhered state of no more than 20% the diameter of the fibers of the substrate such as no more than 10% of the diameter of the substrate. The microfibers may form ridges on the substrate fibers such as along the length of the fibers or about a portion of the fibers and may form bridges between adjacent fibers.

Wettability of a surface can be quantitatively determined by measuring a contact angle of a solid surface. A contact angle of 90° or more indicates a hydrophobic surface, a contact angle of 90° to 110° indicates a weakly hydrophobic surface, 110° to 150° represents a hydrophobic surface and a contact angle of 150° or more indicates a super-hydrophobic surface. The hydrophobic properties mainly depend on chemical properties of the surface and of the micro- and submicron-structures thereof.

The substrate may be of a variety of materials and preferably is fibrous. Examples of substrates include paper, cardboard and fabric. In a preferred set of embodiments the substrate is a fabric and the microfibers become adhered to the surface of the fabric fibers and retain microfiber morphology on the surface of the fabric fibers. The fabric substrate may be a woven, knitted or non-woven fabric and may be in the form of a textile for use in any of a range of applications where water repellency is a useful attribute. The fibers may be of a conventional type having, for example, a diameter more than 10 microns. The melting point of the fabric is not narrowly critical but it will be understood that it will generally retain integrity under the process condition and in use. The substrate may optionally soften under the conditions of the treatment process but generally the substrate will not melt. The substrate may not melt or may have a melting point of at least 200° C. The fabric may be of a synthetic, natural fiber or blends of both types and we have found that the process may be used to impart water repellency to a wide range of fabrics.

Examples of suitable fabric substrates may be selected from the group consisting of cotton, cellulose, acetate, rayon, silk, wool, hemp, polyester, elastane (including LYCRA), polypropylene, polyolefins, polyamide, nylon, aramids (e.g. Kevlar®, Twaron®, Nomex, etc.), acrylic, poly (trimethylene terephthalate) and blends of two or more of these materials. The fibers making-up at least a portion of the substrate, can in one set of embodiments be a thermoplastic polymer. Generally however when the substrate comprises a thermoplastic polymer it has a melting point of over 200° C. Generally it is not significantly deformed under the conditions of the process. Suitable thermoplastic polymers include polyolefins, polyesters, polyamides, polyurethanes, polyvinylchloride, polytetrafluoroethylene, polystyrene, polyethylene terephthalate, biodegradable polymers such as polylactic acid, and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(l-butene) and poly(2-butene); polypentene, e.g., poly(l-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

In a preferred set of embodiments the substrate is a fabric. Examples of fabric include woven, knitted and non-woven fabric articles derived from synthetic fibers, natural fibers or synthetic/natural blends. Moreover, the substrate can have a flat surface or a three-dimensional texture (e.g., as in synthetic fabrics).

In another set of embodiments, the substrate is leather and the microfibers are applied to the substrate by means of spraying, lamination, wet-laying or other means, and the fibers become adhered to the leather.

In another set of embodiments the substrate is used temporarily to assemble a web of microfibers which is either heated on the substrate so that the solid material at least partly flows to produce deformation of the microfibers and adhesion of the microfibers to one another or the web if transferred (optionally in combination with the substrate) to a further substrate such as a fabric before heating to cause the solid material to flow and produce adhesion to the fabric fibers. In the embodiment where the fibers are heated on the substrate the process may be used to form a coherent web of the microfibers. In this embodiment the substrate may be relatively inert to allow subsequent removal of a web of microfibers or may be selected to provide adhesion of the microfibers to the substrate. In accordance with this embodiment the process may be used to provide lamination of a web of microfibers to a fabric. Where the microfibers are heated on a substrate and subsequently contacted with a further fabric substrate the microfibers may be heated on the fabric to provide adhesion to the fabric.

The process comprises subjecting the microfibers to conditions under which the material component of the microfibers is at least partly fluid such that on the surface of the substrate the microfibers deform and provide adhesion of microfibers with other microfibers, adhesion of the microfibers with the substrate or a mixture of adhesion with other microfibers and with the substrate. In one set of embodiments the microfibers comprise a material, which is at least partly fluid at ambient temperature. In a further set of embodiments the microfibers are heated to render them fluid or more fluid.

The microfibers may be rendered at least partly fluid by using a solid material adapted to be softened by a solvent and treating the microfibers with the softening solvent prior to, during or after application of the dispersion to the substrate. Treatment of microfibers on the substrate may be useful where the solvent and material can be selected to provide softening and deformation of the microfibers without adversely affecting the substrate. Any organic solvent which softens the microfibers and does not adversely impact the mechanical properties in any significant way can be used. Such organic solvents may be miscible or compatible with water, if desired. However, this is not necessary, as traditional organic solvents which are completely immiscible with water can also be used. Conventional low-boiling organic solvents are preferred. Mixtures of different organic solvents can also be used.

Example of solvents which can be used to provide softening of microfibers, particularly microfibers comprising a polymeric material include common solvents such as aromatic and aliphatic (both saturated and unsaturated) hydrocarbon solvents, oxygenated organic solvents, other polar organic compounds and naturally-occurring solvents can be used. Specific examples include mineral spirits, various petroleum fractions such as gasoline, kerosene and the like, esters, organic acids, alcohols, ketones and mixtures thereof. Preferably the solvents are low boiling, such as having a boiling point of no more than 150° C. or no more than 120° C.

In one set of embodiments the dispersion liquid comprises a solvent, which provides softening of the solid material. This embodiment is useful where it is desirable or convenient not to heat the substrate. For example the use of solvent softened microfibers is particularly applicable to providing durable water repellency to paper products cardboard or leather.

In a further set of embodiments the material present in the microfibers is adapted to flow when heated to a temperature of no more than 160° C. such as no more than 150° C. or no more than 130° C. or no more than 120° C. In this set of embodiments the temperature to which the microfibers are heated may be in the range of from 30° C. to 180° C., preferably from 50° C. to 180° C. The material may flow as a result of softening or at least partially melting under conditions to which the microfibers are subject prior to, during or after applying the dispersion to the substrate. The solid material may be chosen to become at least partly fluid by use of a solid material composition comprising a material, which has a softening point lower than the temperature to which the microfibers are to be heated. In a further set of embodiments the microfibers may comprise a material having a melting point lower than the temperature to which the microfibers are subjected.

The microfiber material and conditions of treatment may be chosen having regard to the nature of the substrate and the conditions under which the substrate remains suitable for the intended purpose. For example in one set of embodiments the substrate has a softening point of at least 200° C. and the microfibers include a solid material comprising a component having a softening point of no more than 160° C., preferably no more than 140° C. such as no more than 120° C. In this set of embodiments the component of the solid material preferably has a softening point of at least 20° C., preferably at least 30° C., preferably at least 35° C. This embodiment is particularly useful in treatment of fabric substrates, which may be comprised of synthetic or natural fibers. The deformation and adhesion of the microfibers at or above the softening point of a component material may be assisted by the application of pressure. The substrate with applied microfibers may, for example be subjected to pressure (particularly in the case of fabric substrates) by passing through opposed (calender) rollers. In some embodiments the softening point (Ts) of a polymer can be defined by standard industrial methods (i.e., ASTM D 1525 or ISO 306).

It may be advantageous to subject the microfibers to a temperature above their melting point for a period of time sufficient for the solid material to at least partly flow. In one set of embodiments the solid comprises a component having a melting point of no more than 160° C. preferably no more than 140° C. such as no more than 120° C. Generally the melting point will be at least 50° C.

In accordance with an embodiment there is provided a process for providing water repellent fabric substrate comprising:

providing a dispersion in a liquid of discrete-length microfibers comprising a solid material;

applying the dispersion to the substrate;

removing liquid from the fibers and substrate; and

heating the fibers at a temperature in the range of from 110° C. to 180° C., wherein the solid material is at least partly fluid at a temperature of no more than 160° C., such that the microfibers deform to provide adhesion of microfibers with other microfibers, adhesion of the microfibers with the substrate or a mixture of adhesion with other microfibers and with the substrate.

The microfibers are typically heated to above the softening point of at least a portion of the material of the microfibers and preferably above the melting point of at least a portion of the material. The required time period for heating of the microfibers to provide deformation and adhesion will depend on the softening or melting point of at least a portion of the solid material and the temperature. In one set of embodiments the fibers are heated to a temperature above the melting point of the solid material (such as at least 20° C. or at least 40° C. above the melting point) to provide deformation and adhesion relatively quickly such as over a period of no more than 20 minutes or such as no more than 10 minutes.

It will be appreciated that there is a balance to be struck between causing the fibers to deform sufficiently to adhesion and retaining the morphology of the fibers. This balance may be struck by controlling the temperature, the period of heating and the composition of the fibers. For example, in one embodiment the proportion of the microfiber material which is caused to flow may be relatively small, such as less than 50% or less than 20% by weight and the microfiber composition may comprise more than 50% by weight of a material which does not become fluid at the temperature at which the fibers are heated. This embodiment may be exemplified in the use of multicomponent fibers comprising two or more solid components selected from the group consisting of a component which becomes fluid under the conditions to which the microfibers are subject to provide at least partial fluidity and a component which does not flow under the conditions to which the microfibers are subjected. The microfibers may, for example comprise inorganic material fillers which do not become fluid under the conditions to which the microfibers are subject together with an organic material such as a polymer which is adapted to be fluid under the treatment conditions, for example, by having a softening point lower than ambient and/or softening when heated under the conditions used.

In one set of embodiments the material, preferably a polymeric material which may be a synthetic or natural polymeric material, has a Tg in the range of from −20° to 100° C. such as from −20 to 80° C. and is subject to a temperature above the Tg and in the range of from ambient temperature to 180° C. In a preferred set of embodiments the temperature is above the melting point of the material and is in the range of from 50° C. to 180° C. such as from 110° C. to 180° C.

In one set of embodiments at least a portion of the microfiber material comprises functional groups or moieties which facilitate softening of a portion of the material to allow the material to at least partially flow under the conditions to which the microfibers are subject. Examples of such materials may be selected from the group consisting of polymers, polymer precursors and waxes. The microfiber dispersion may further comprise monomers or other reagents such as cross-linking agents to facilitate reaction before or during the heating process.

Examples of waxes include a petrochemical wax, a natural wax, a paraffin wax, an artificial wax, or a combination thereof. Suitable waxes in one set of embodiments having a melting point of 45° C. to 90° C.

In exemplary embodiments of the process of the invention, the microfiber-forming material may include at least one polymer selected from the group consisting of egg proteins, polysaccharides, polypeptides, alginates, chitosan, starch, collagen, silk fibroin, polyurethanes, polyacrylic acid, polyacrylates, polyacrylamides, polyesters, polyolefins, boronic acid functionalised polymers, polyvinylalcohol, polyallylamine, polyethyleneimine, polyvinyl pyrrolidone), poly(lactic acid), polyether sulfone and inorganic polymers.

In some embodiments the microfibers comprise polymer such as at least one polymer selected from the group consisting of a natural polymer, a synthetic polymer, and combinations thereof. Natural polymers may include polysaccharides, polypeptides, glycoproteins, and derivatives thereof and copolymers thereof. Polysaccharides may include agar, alginates, chitosan, hyaluronan, cellulosic polymers (e.g., cellulose and derivatives thereof as well as cellulose production by-products such as lignin) and starch polymers. Polypeptides may include various proteins, such as silk fibroin, lysozyme, collagen, keratin, casein, albumen, gelatin and derivatives thereof. Derivatives of natural polymers, such as polysaccharides and polypeptides, may include various salts, esters, ethers, and graft copolymers. Exemplary salts may be selected from sodium, zinc, iron, magnesium and calcium salts.

Examples of synthetic polymers which may be employed in the process of the invention may fall within one of the following polymer classes: polyolefins, polyethers (including all epoxy resins, polyacetals, poly(orthoesters), polyetheretherketones, polyetherimides, poly(alkylene oxides) and poly(arylene oxides)), polyamides (including polyureas), polyamideimides, polyacrylates, polybenzimidazoles, polyesters (e.g. polylactic acid (PLA), polyglycolic acid (PGA), poly(lactic-co-glycolic acid) (PLGA)), polycarbonates, polyurethanes, polyimides, polyamines, polyhydrazides, phenolic resins, polysilanes, polysiloxanes, polycarbodiimides, polyimines (e.g. polyethyleneimine), azo polymers, polysulfides, polysulfones, polyether sulfones. oligomeric silsesquioxane polymers, polydimethylsiloxane polymers nitrile rubbers, latex rubbers, polyvinyls, melamine and phenolic resins, polyacids, olefin copolymers and mixtures thereof and copolymers thereof.

It will be understood by those skilled in the art that suitable resins of the different polymer types are available with a range of Tg and melting points depending on molecular weight, comonomers, plasticisers and formulation additives (other than plasticisers). Suppliers and manufacturers generally provide details of the Tg and melting point of resins and fiber products, which allow appropriate selection of thermoplastic fibers and/or microfiber material for use in the invention, in accordance with the teaching herein, without undue experimentation.

In some embodiments, functionalised synthetic polymers may be used. In such embodiments, the synthetic polymers may be modified with one or more functional groups. Examples of functional groups include boronic acid, alkyne or azido functional groups. Such functional groups will generally be covalently bound to the polymer. The functional groups may allow the polymer to undergo further reaction (for example, to allow fibers formed with the functionalised polymer to be immobilised on a surface), or to impart additional properties to the fibers. For example, boronic acid functionalised fibers may be incorporated in a device for glucose screening.

In one set of embodiments the microfibers comprise a thermoplastic material which softens or melts with heating during the process. As mentioned above the preferred thermoplastics for providing a material which is at least partly fluid under heating of the microfibers have a softening point of no more than 160° C. and preferably at least from −20° C. such as from at least 20° C. The melting point of the material which is at least partly fluid under heating of the microfibers is preferably from 30° C. to 160° C. and more preferably from 50° C. to 160° C. Examples of thermoplastic polymers include, but are not limited to, polyolefins, such as polyethylene, polypropylene, and polybutylene (examples of suitable polyolefins include polyolefin low melt resins and copolymers with functionalised unsaturated monomers such as acrylic acid, methacrylic acid or EVA, halogenated polymers, such as polyvinyl chloride, polyesters, polyester/polyethers, polyamides, polyurethanes particularly polyurethanes comprising soft segments, polyurea, unsaturated acid polymers such as acrylic acid polymers and methacrylic acid polymers acid, epoxy resins, phenolics, elastomers, modacrylic, novoloid, nytril, aramid, spandex, vinyl polymer, vinal, and vinyon, as well as homopolymers, copolymers, or terpolymers in any combination of such monomers. The thermoplastic solid can also be a mixture or a blend of one or more of the aforementioned synthetic materials and a natural material such as wool, linen, cotton, silk, or a combination thereof.

Thermoplastic polymers having a softening temperature of up to 160° C. may be used in the process with application of pressure, such as by a calendering process, to provide adhesion of softened microfibers to one another or to the substrate. The softening of the microfibermay be restricted to a portion of the material adapted to be fluid by defining a temperature window between melting and glass transition temperature (Tm-Tg) and/or time duration above the glass transition temperature or melting point for which heat is applied. Too short a time span will end up unsoftened surface resulting in less adhesion. On the other hand, heating for a prolonged period (particularly when pressure is applied) may result in an undesirable loss of microfiber morphology.

In a particularly preferred set of embodiments the solid material, comprises a thermoplastic polymer having a melting point of from 50° C. to 160° C. Microfibers of thermoplastic polymers having a melting point of from 50° C. to 160° C. may be heated to at or above the melting point for a time period sufficient to cause the polymer to at least partly flow to provide adhesion to the other microfibers and/or substrate. The temperature and time for which a temperature at or above the melting point is maintained will govern the extent to which the shape of the microfiber is distorted. Generally it is preferred that the general morphology of the microfibers is maintained on providing adhesion. If the microfibers are heated at too high a temperature and/or for too long a period the morphology of the microfiber will be substantially lost and the extent of water repellency may be reduced.

In one set of embodiments the solid material comprises a cross-linkable polymeric material preferably adapted to undergo crosslinking by a mechanism selected from covalent, ionic, complexation, entanglement, hydrophobic interactions, and where the cross-linking is triggered by thermal, optical, electrical processes, or by exposure to appropriate crosslinking catalysts or crosslinking molecules.

In a particularly preferred aspect the solid material (preferably polymeric material) is not hydrophobic or only weakly hydrophobic. The non-hydrophobic material when applied as a continuous two dimensional film layer will provide a contact angle of less than 90° and the weakly hydrophobic material has a contact angle of 90° to 110°. More preferably the solid material is a non-hydrophobic material. We have found that the non-hydrophobic materials may provide, contrary to what was expected, an excellent level of durable water repellency. The option of using non-hydrophobic materials, which may have hydrophilic properties, provides significant advantages in formulating dispersions. In many instances such material may be formulated as aqueous dispersions facilitating convenient handling, reduced chemical waste and reduced cost. Accordingly in a preferred set of embodiment the process comprises:

providing an aqueous liquid dispersion of discrete-length microfibers comprising a polymeric material having a softening point of no more than 160° C., preferably a melting point of no more than 160° C.;

applying the dispersion to a substrate;

removing the aqueous liquid from the fibers and substrate; and

heating the fibers to a temperature above the softening point of the material (preferably above the melting point of the material) and in the range of from 110° C. to 180° C., such that the microfibers deform to provide adhesion of microfibers with other microfibers, adhesion of the microfibers with the substrate or a mixture of adhesion with other microfibers and with the substrate; and

wherein the polymer preferably has a wettability contact angle of less than 110° and preferably less than 90°.

In a particularly preferred embodiment the microfiber comprises a homopolymer or copolymer of an unsaturated acid such as acrylic acid or methacrylic acid. Such polymers generally have a contact angle of less than 90° depending on the content of unsaturated acid. Generally the unsaturated acid will comprise at least 5% w/w of the monomer composition of the polymer. In a particularly preferred embodiment the fiber comprises a copolymer of acrylic acid and a comonomer comprising at least one selected from olefins, urethanes and acrylates. More preferably the co-monomer is a hydrocarbon, preferably an olefin. In a preferred set of embodiments the microfibers comprise a copolymer of ethylene and acrylic acid preferably comprising from 1% to 20% acrylic acid.

In a further preferred set of embodiments the microfibers comprise a blend of a relatively hydrophobic component such as a polyolefin and a relatively hydrophilic component preferably a polymer of an unsaturated acid such as acrylic or methacrylic acid.

The microfiber dispersion may be applied to the substrate in a wide range of loadings depending on whether the fiber is to form a web in its own right or to provide durable water repellency to a substrate. In one set of embodiments the microfiber dispersion is applied to the substrate with a loading in the range of from 0.001 g to 50 g per square meter. In a preferred set of embodiments the substrate is a fabric and the dispersion is applied at a rate of from 0.01 g to 5 g of microfiber per square metre of fabric. The rate of 0.01 g to 5 g of microfiber per square meter allows a very significant improvement in water repellency to be attained in a process which is readily scalable and economical.

The proportion of microfiber composition which is adapted to be fluid under the processing conditions is generally at least 20% by weight, preferably at least 50% by weight. The optimum proportion will depend on the specific materials and processing conditions. Where only a portion of the microfiber composition is adapted to be fluid under the processing conditions the balance of the microfiber composition may be selected from any of the natural or synthetic material described above for use in the substrate.

The process comprises providing dispersion in a liquid of the discrete-length fibers. The dispersion medium may include at least one solvent selected from the group consisting of water, cryogenic liquids (e.g. liquid nitrogen) and organic solvents preferably selected from classes of oxygenated solvents (e.g., alcohols, glycol ethers, ketones, esters, and glycol ether esters), hydrocarbon solvents (e.g., aliphatic and aromatic hydrocarbons), and halogenated solvents (e.g., chlorinated hydrocarbons).

In some embodiments, the dispersion medium includes a liquid selected from the group consisting of protic liquids and non-protic liquids. In particular embodiments, the dispersion medium includes a liquid selected from the group consisting of water, an alcohol (e.g. C1 to C12 alcohols), an ionic liquid, a ketone (e.g. acetone), and dimethyl sulfoxide. Mixtures of liquids may be used, for example, a mixture of water and alcohol. As described above such liquids may be solvents for a component material of the microfiber and provide deformation and adhesion of the microfiber.

In particular embodiments, the dispersion medium includes an alcohol. The dispersion medium may include at least 25% (v/v), at least 50% (v/v), or at least 75% (v/v) alcohol. Exemplary alcohols include C2 to C4 alcohols, such as ethanol, isopropanol and n-butanol. Butanol is a desirably included in the dispersion medium in some embodiments as it is able to generate emulsions when in contact with water. In some embodiments, the alcohol may be volatile, having a low boiling point. A volatile solvent may be more easily removed from the polymer fibers after isolation of the fibers.

In one set of embodiments it is preferred that the dispersion medium include no more than 50% (v/v), no more than 20% (v/v), no more than 10% (v/v), or no more than 5% (v/v) glycerol. In one set of embodiments it is a proviso of the process that the dispersion medium be substantially free of glycerol. It can be desirable to exclude glycerol from the dispersion medium as glycerol increases the viscosity of the dispersant and may be difficult remove from the formed fibers when it is desired to isolate the fibers.

In some embodiments the dispersion medium may be a naturally occurring liquid derived from natural sources. The natural liquid may include a naturally occurring coagulant. An example of a natural liquid that may be used as a dispersion medium is milk, which contains calcium salts and which has been found to be useful as a dispersion medium for the formation of fibers from polymer solution containing sodium alginate.

A range of processes may be used to prepare the dispersion. In one set of embodiments the process further comprises a preliminary step of forming the dispersion of microfibers by subjecting a dispersion of microfiber forming liquid to high shear conditions. One such process is described in International Publication WO2013/056312 the contents of which are herein incorporated by reference.

The process for the preparation of microfibers may include the steps of:
(a) introducing a stream of fiber forming solution or dispersion into a dispersion medium;
(b) forming a filament from the stream of polymer solution in the dispersion medium; and
(c) shearing the filament under conditions providing fragmentation of the filament and formation of microfibers.

Additives may be present to stabilise the dispersion, to assist in application or compatibility with the substrate or to provide additional treatment of the substrate to enhance water repellency and/or confer one or more other desirable properties to the substrate. Examples of such additives include antioxidants, weather stabilizers, light stabilizers, antiblocking agents, lubricants, nucleating agents, pigments, softeners, hydrophilizing agents, auxiliaries, water repellents, fillers, antibacterial agents and flame retardants. These additives may be added as a component of the dispersion of microfibers or may be applied to the substrate as a separate step before during or after application of the dispersion by methods such as spraying, dipping, padding or roller application.

Examples of components which may be present to stabilise the dispersion of microfibers include surfactants which may stabilise the dispersion and inhibit agglomeration of the microfibers. The use of surfactants and the type of surfactant may be determined by those skilled in the art having regard to the polarity of the microfiber material and the nature of the solvent.

In one set of embodiments the microfibers comprise at least one inorganic particulate filler material in an amount of up to 40% by weight of the microfiber composition such as from 1% to 30% or from 1% to 20% by weight of the microfiber composition.

In a further set of embodiments the dispersion further comprises microfiber, which does not deform on heating to provide adhesion. The amount of additional microfiber may be determined having regard to its composition and the desired properties to be provided to the substrate surface. In one set of embodiments the additional microfiber may be present in an amount of up to 60% by weight of the total microfiber component.

The dispersion may comprise one or more additional dispersed phases of particulate or liquid surface treatment materials. Examples of surface treatment materials may include water repellent agents which may be fluorochemicals or be free of fluorochemicals. Other examples of surface treatment include mineral fillers such as silicates, clays and the like.

Examples of fluorine-free water repellents which may be used in addition to the microfibers include organic dendrimers, polyurethane, wax mixture, organic silicon, inorganic-organic mixing materials, metal-oxide particles or metallic-particles. In a preferable embodiment, the present invention substantially comprises no fluorine-containing component. Said “substantially comprises no fluorine-containing component” means there is not any fluorine-containing materials used in the present process and there is no need for a fluorine-containing component in order to achieve an excellent durable water repellency functionality.

One example of substrates which may benefit from use of fluorocarbons such as C6 fluorocarbons in addition to the process are fabrics in which reduced drag is important such as reduced drag in air or water. Swimwear is an example of a fabric use that requires not only durable water repellency but in competitive swimwear scenarios it would be advantageous to additionally achieve improved drag properties. Reducing the coefficient of drag for a fabric with a surface treatment may reasonably be expected to play a role in reducing the level of hydrodynamic drag across the fabric during swimming conditions.

The dispersion of microfibers may be applied to the substrate by any suitable process known in the industry for treatment of the relevant substrates such as fabrics paper or cardboard. In the preferred embodiments where the substrate is a fabric the dispersion may be applied by wet impregnation of the substrate, filtering onto the substrate (for example, by using a vacuum filtration apparatus), spraying the dispersion, applying the dispersion by padding, painting or coating (for example by blade, foam, or roller). The dispersion may be applied to all surfaces of the substrate or may be selectively applied to those surfaces to be rendered water repellent.

In a further set of embodiments the microfiber dispersion is applied to the substrate by a printing method such as sublimation printing, transfer printing, screen printing, ink jet printing or other print deposition method.

In a further embodiment the microfibers are firstly applied to one substrate and dried as a fiber web or mat before being transferred to the substrate on which it is to provide water repellency and heated to provide adhesion to that substrate.

In general the effect of the treatment on water roll-off may be controlled by adjustment of the microfiber composition, microfiber loading and the use of additives (particularly additional water repellents). In some embodiments it is preferred to have a minimal level of contact angle hysteresis when surfaces are tilted. Substrates may be modified using the process to provide a higher water contact angle and small tilt angle or water roll-off angle (also commonly referred to as the Lotus leaf effect) or alternatively the process may be used to provide a higher contact angle and a high tilt of roll-off angle.

Generally the preferred embodiment is to achieve modified surfaces with a low roll-off angle that provide roll off at a tilt angle of no more than 20° from the horizontal and in some cases no more than 10°. The low roll-off angle can generally be achieved with a relatively low loading of microfibers such as from 0.05 to 2% w/w although higher loadings may be used if desired. We have also found that in many cases the use of additional water repellents such as fluorine or non-fluorine water repellents may favour the preparation of low roll-off angle coated substrates.

In one set of embodiments the level of hydrophobicity provided by the process results in a strong water pinning effect. Water pinning in some embodiments may result where no additional water repellent is used with the microfibers and the microfibers are used at a relatively high loading on the substrate such as at least 2% w/w. The ability to retain a well-defined drop of liquid on a substrate may have great technological significance, including the ability to spectroscopically probe a single drop over extended periods of time. The pinning of a water drop for very long times without affecting the properties of components dissolved or dispersed in the water is usually measured in terms of a pinning force. Further to this, the related applications involving concepts of hydrophobicity or hydrophilicity present challenges, especially in attempting to create surfaces that can pin droplets with relatively large contact angles. In embodiments where water pinning is observed the process may allow fabrics to be modified to provide a water droplet roll-off angle of at least 70°, preferably at least 75° and most preferably at least 80° from horizontal. Where higher roll-off angle from horizontal indicates better water pinning performance.

The pinning force of a liquid droplet can be determined from the equation

F=mg sin α

where α is the sliding angle, or angle of tilt of the surface (from 0° to 90° from horizontal) necessary to produce sliding (or roll-off) of the liquid droplet, m is the mass of the liquid droplet and g is the acceleration of gravity (alternatively, mg=weight of the liquid droplet in grams). In treatments which provide water pinning we have found that the pinning force may be of the order of 1×10⁻³ g or more.

The process generally provides highly hydrophobic surfaces which generally have a contact angle of at least 120°, preferably at least 125° such as at least 130° or at least 140°. The process may be used to improve the water repellancy of a wide range of materials, particularly fibrous materials and generally the substrate prior to treatment will have a contact angle of no more than 100° such as not more than 90°. The process may also be conveniently combined with normal substrate processing methods such as textile processing and treatments. In addition the components used in the invention are generally less expensive than many water repellents and exhibit excellent durability as a result of adhesion of the water repelling microfibers to the substrate.

The fabrics modified in accordance with the process may be tested by the spray test AATCC 22 (or alternatively ISO 4920-1981 and typically provide spray ratings 100 initially and at least 80 after 20 home laundry cycles. In addition the process allows fabrics to be prepared with soil release properties as determined by AATCC 130.

The following examples illustrate the invention in further detail but the examples should not be construed as limiting the scope of the invention as described herein.

### EXAMPLES

The general procedure for preparation of the microfiber dispersion is in accordance with WO 2013056312 and involves:
1. A fiber-forming liquid is introduced in a non-solvent or semi-solvent system under shear, and fibers are collected as a result.
2. The fiber suspension is further diluted in ethanol, to achieve the fiber concentrations required by the coating density of interest.

Process of Forming Fiber Suspension

In the process of forming the dispersions the fiber forming liquid was injected, via a 21G metal syringe, using a syringe pump, at a rate of 20 mL/min, into cold butanol. For every 300 mL of butanol, held in an 800 mL beaker, 10 mL of polymer was injected. Fibers were produced according to the published method (method patent: International Patent Appln. PubIn. WO2013/056312), by using an Ultraturrax shear mixer, S50N-W65 SK crushing head, operated at 6400 rpm.

Stabilisation

In some instances, the fiber morphology may be attenuated through heating or exposure to water. To prevent this, stabilisation with appropriate amounts of crosslinker or appropriate other solvent treatments are used.

Where silk fibroin is present, stabilisation with ethanol may be necessary. This is achieved by diluting the starting fiber suspension in ethanol and letting it sit overnight. Dilutions of at least 1 in 100 are used to obtain suitable water insolubility.

In other instances (Fixamin PUK) crosslinking using CaCl₂) may be used. In this case, CaCl₂) is added to the fiber suspension in 1-butanol and the mixture let sit for at least 1 hr. The amount of CaCl₂) to be added can determine the level of morphological retention attained.

Process A: Padding

1. The fabric is cut in 240 mm×320 mm samples.
2. The coating mixture inclusive of one of all of the following is added between two horizontal-axis padding rolls which are held in tight contact under pressure: microfiber suspensions, water repellent components or their precursors, fillers, crosslinkers, additives are used in the water-repellency-generating process.
3. The rolls are made to turn in such a way that:
1. A liquid reservoir can be maintained between the rolls (thanks to side-barriers)
2. The rolls can rotate in opposing fashion
3. A fabric can be fed into the gap above the junction point for the rolls, and
4. A fabric can be immersed in the liquid bath and inserted in the device through the bath and in such a way that once the fabric comes in close proximity of or at the contact point between the rolls, it is pulled downwards and is subjected to pressure, exiting on the other side of the roll-assembly.
   4. The so-coated fabric is then heat treated as per required thermal treatment, typically in a stenter oven at 120° C. for 2 minutes and 150° C. for 3 minutes.

Process B

A suspension of fibers in 1-butanol/ethanol was diluted to different concentrations and filtered through a 47 mm diameter fabric swatch using a Millipore Sterifile unit, and low reticulated vacuum. The fabric was rested above a polypropylene grid (1 mm mesh size) to enable uniform vacuum be applied to the whole surface.

The method allows control on the solids deposited on the fabric. The fabric was wetted first with ethanol, the fiber dispersion was flow filtered through the fabric membrane, and then a rinse with ethanol and a rinse with water were followed by filtration of different HeiQ Barrier ECO/HeiQ Effect SAX combinations. The fabrics were immediately removed from the filtration setup and heat treated in a stenter machine at 120° C. for 2 minutes and 150° C. for 3 minutes.

Process C

A suspension of fibers in 1-butanol/ethanol was diluted to different concentrations and spray coated on fibrous substrates, using a commonly available spray gun, operated in a fumehood, and reticulated compressed air. The fabrics were laid on the fumehood tray and coating was applied by hand at a rate of 7 sweeps per minute, where one sweep consists in one single (moving) spray action to achieve coverage of the whole sample. The fibres were softened and deformed on the substrate as a result contact with the 1-butanol/ethanol solvent composition in the microfiber dispersion.

In Process A and Process B the ECO/SAX combinations all included 1% HeiQ Effect SAX and varying concentrations of HeiQ Barrier ECO.

SPRAY TEST performance of different treatments is determined on fabric, before and after standard washing.

Materials

The following materials where referred to have the main functional component listed below:
PRIMACOR 59901—Products under the trade name PRIMACOR are obtained from Dow Chemical. They generally comprise low molecular weight copolymer of ethylene and acrylic or methacrylic acid. By low molecular weight, these include polymers having high melt index values. A particularly preferred copolymer is PRIMACOR 59901 which has a melt index of about 1300 dg/min under ASTM D1238 Condition (B), 125° C./2.16 kg.
PRIMACOR 59901 comprises about 20 weight percent acrylic acid and has a DSC melting point of 75° C. and a Vicat Softerning point of about 40° C.
FIXAMIN PUK is a polyurethane based adhesive available from Büfa.
HeiQ BARRIER ECO (also referred to herein as “ECO”) is a fluorine free (non-fluorinated) water repellent comprising hyperbranched polymers available from HeiQ Materials AG.
HeiQ BARRIER HM-C6 contains C6 fluorine functionalized (fluorinated) polymer resins used as a water repellent coating and is available from HeiQ Materials AG.
HeiQ EFFECT SAX (also referred to herein as“SAX”) is a blocked prepolymer based on isocyanates available from HeiQ Materials AG.
FIXAMIN NL M06 is a nitrile latex suspension, available from Büfa.
FIXAMIN AC WO1 is an acrylic acid ester dispersion in water, available from Büfa.
FIXAMIN AC W03 is an acrylic acid ester dispersion in water, available from Büfa.
FIXAMIN AC W38 is an acrylic acid ester dispersion in water, available from Büfa.
FIXAMIN BL K88 is a styrene-butadiene copolymer dispersion in water, available from Büfa.
FIXAMIN CP55 is a mixture of aliphatic polyester-polyurethane and acrylic-acid ester copolymer dispersion in water, available from Büfa.
FIXAMIN PU M13 is an aliphatic polyester polyurethane based adhesive available from Büfa.
FIXAMIN PU WO1 is a mixture of polyacrylate and polyurethane dispersion in water, available from Büfa.
Chitosan is a natural-material-derived polymer and is available from Sigma Aldrich.
Sodium alginate is a natural-material-derived polymer and is available from VWR International.
Xanthan gum is a natural material, and is available from Lotus and from Sigma Aldrich.
Polyvinylalcohol is available from Sigma Aldrich.
Silk fibroin is derived from silk cocoons, as described in WO2013056312A1.
Egg albumen was extracted from freshly sourced hen-eggs.
Polyethyleneimine is available from Sigma Aldrich.
Poly(N-allylamine) is available from Sigma Aldrich.
Polystyrene sulfonate is available from Polysciences and Sigma Aldrich.
Gelatine is available from VWR International and Sigma Aldrich.
Carrageenans are available from Sigma Aldrich.
Shellac Wax is available from Sigma Aldrich.
Guar Gum is available from Sigma Aldrich.
Beeswax is available from Sigma Aldrich.
Silica 1 and “fumed silica 1” referred to in the tables and Figures is amorphous fumed silica.
Silica 2 referred to in the tables and Figures is amorphous precipitated silica.
Mixed silica referred to in the tables and drawings is a mixture of silica 1 and silica 2.

### Examples 1 to 129 and Comparative Examples (CE) 1 to 7

The process described above is carried out using a polyamide-elastane fabric and materials listed in the Table 1 and where indicated the spray test performance was determined on the resulting treated fabric before and after being subject to washing.

TABLE 1
Samples prepared according to process B, using polyamide-elastane fabrics.

| | | | | | | | | Spray test |
|---|---|---|---|---|---|---|---|---|
| | | Micro | | HeiQ | HeiQ | HeiQ | | performance |
| | | Fibres | | Barrier | Barrier | Effect | | after washing |
| | Micro Fibre | deposited | | ECO | HM-C6 | SAX | Spray test | (# of heavy |
| | material | (g/(m of | | concentration | concentration | concentration | performance | load washes in |
| EX. | deposited | fabric)²) | | (vol. %) | (vol. %) | (vol. %) | as made | brackets) |
| CE1 | None | 0 | | 4 | 0 | 1 | 95 | 95 (10) |
| CE2 | | 0 | | 3 | 0 | 1 | 95 | 95 (10) |
| CE3 | | 0 | | 2 | 0 | 1 | 95 | 95 (10) |
| CE4 | | 0 | | 1 | 0 | 1 | 95 | 85 (10) |
| CE5 | | 0 | | 0.5 | 0 | 1 | 70 | 80 (10) |
| CE6 | | 0 | | 0.25 | 0 | 1 | 50 | 75 (10) |
| CE7 | | 0 | | 0.1 | 0 | 1 | 0 | 60 (10) |
| 1 | Primacor | 0.48 | g/m² | 0.25 | 0 | 1 | 60 | 75 (10) |
| 2 | 5990I | 1.58 | g/m² | 0.25 | 0 | 1 | 60 | 80(10) |
| 3 | | 0.48 | g/m² | 0.5 | 0 | 1 | 80 | 85 (10) |
| 4 | | 1.58 | g/m² | 0.5 | 0 | 1 | 95 | 90 (10) |
| 5 | | 0.48 | g/m² | 1 | 0 | 1 | 95 | 90 (10) |
| 6 | | 1.58 | g/m² | 1 | 0 | 1 | 100 | 95 (10) |
| 7 | | 0.48 | g/m² | 2 | 0 | 1 | 100 | 95 (10) |
| 8 | | 1.58 | g/m² | 2 | 0 | 1 | 100 | 95 (10) |
| 9 | | 0.48 | g/m² | 3 | 0 | 1 | 100 | 95 (10) |
| 10 | | 1.58 | g/m² | 3 | 0 | 1 | 100 | 100 (10) |
| 11 | | 0.48 | g/m² | 4 | 0 | 1 | 100 | 100 (10) |
| 12 | | 1.58 | g/m² | 4 | 0 | 1 | 100 | 100 (10) |
| 13 | | 1.58 | g/m² | 0 | 0 | 0 | 60 | 60 (10) |
| 14 | | 0.48 | g/m² | 0.5 | 0 | 1 | 80 | 85 (10) |
| 15 | | 1.58 | g/m² | 0 | 0 | 0 | 60 | 60 (10) |
| 16 | Albumen | 0.74 | g/m² | 1 | 0 | 1 | 90 | |
| 17 | | 0.74 | g/m² | 0.5 | 0 | 1 | 75 | |
| 18 | | 0.74 | g/m² | 0.25 | 0 | 1 | 70 | |
| 19 | | 0.74 | g/m² | 0 | 0 | 1 | 0 | |
| 20 | Primacor | 0.92 | g/m² | 1 | 0 | 1 | 90 | |
| 21 | 5990I (60% w) | 0.92 | g/m² | 0.5 | 0 | 1 | 80 | |
| 22 | Albumen | 0.92 | g/m² | 0.25 | 0 | 1 | 70 | |
| 23 | (40% w) | 0.92 | g/m² | 0 | 0 | 1 | 0 | |
| 24 | Primacor | 0.8 | g/m² | 3 | 0 | 1 | 95 | 95 (3) |
| 25 | 5990I + silk | 0.8 | g/m² | 2 | 0 | 1 | 95 | 90 (3) |
| 26 | fibroin (30% w) | 0.8 | g/m² | 1 | 0 | 1 | 90 | 85 (3) |
| 27 | | 0.8 | g/m² | 0.5 | 0 | 1 | 80 | 75 (3) |
| 28 | | 0.8 | g/m² | 0.25 | 0 | 1 | 60 | 65 (3) |
| 29 | | 0.8 | g/m² | 0 | 0 | 0 | 0 | 50 (3) |
| 30 | Primacor | 1.6 | g/m2 | 2 | 0 | 1 | 100 | 100 (3) |
| 31 | 5990 | | | 1 | 0 | 1 | 90 | 90 (3) |
| 32 | Fixamin | | | 0.5 | 0 | 1 | 85 | 80 (3) |
| 33 | PUK − high | | | 0.25 | 0 | 1 | 80 | 80 (3) |
| 34 | crosslinking | | | 0 | 0 | 0 | 0 | 0 |
| 35 | | 0.8 | g/m2 | 2 | 0 | 1 | 100 | 100 (3) |
| 36 | | | | 1 | 0 | 1 | 95 | 90 (3) |
| 37 | | | | 0.5 | 0 | 1 | 85 | 80 (3) |
| 38 | | | | 0.25 | 0 | 1 | 80 | 75 (3) |
| 39 | | | | 0 | 0 | 0 | 0 | 0 |
| 40 | | 0.5 | g/m2 | 2 | 0 | 1 | 100 | 95 (3) |
| 41 | | | | 1 | 0 | 1 | 90 | 85 (3) |
| 42 | | | | 0.5 | 0 | 1 | 85 | 80 (3) |
| 43 | | | | 0.25 | 0 | 1 | 75 | 75 (3) |
| 44 | | | | 0 | 0 | 0 | 0 | 0 |
| 45 | | 0.3 | g/m2 | 2 | 0 | 1 | 95 | 95 (3) |
| 46 | | | | 1 | 0 | 1 | 90 | 85 (3) |
| 47 | | | | 0.5 | 0 | 1 | 75 | 75 (3) |
| 48 | | | | 0.25 | 0 | 1 | 75 | 75 (3) |
| 49 | | | | 0 | 0 | 0 | 0 | 0 |
| 50 | Primacor | 1.6 | g/m2 | 2 | 0 | 1 | 95 | |
| 51 | 5990I (DOW) − | | | 1 | 0 | 1 | 95 | |
| 52 | Fixamin | | | 0.5 | 0 | 1 | 85 | |
| 53 | PUK − low | | | 0.25 | 0 | 1 | 80 | |
| 54 | crosslinking | | | 0 | 0 | 0 | 0 | |
| 55 | | 0.8 | g/m2 | 2 | 0 | 1 | 100 | |
| 56 | | | | 1 | 0 | 1 | 95 | |
| 57 | | | | 0.5 | 0 | 1 | 90 | |
| 58 | | | | 0.25 | 0 | 1 | 70 | |
| 59 | | | | 0 | 0 | 0 | 0 | |
| 60 | | 0.5 | g/m2 | 2 | 0 | 1 | 100 | |
| 61 | | | | 1 | 0 | 1 | 95 | |
| 62 | | | | 0.5 | 0 | 1 | 80 | |
| 63 | | | | 0.25 | 0 | 1 | 70 | |
| 64 | | | | 0 | 0 | 0 | 0 | |
| 65 | | 0.3 | g/m2 | 2 | 0 | 1 | 95 | |
| 66 | | | | 1 | 0 | 1 | 95 | |
| 67 | | | | 0.5 | 0 | 1 | 80 | |
| 68 | | | | 0.25 | 0 | 1 | 70 | |
| 69 | | | | 0 | 0 | 0 | 0 | |
| 70 | Silk Fibroin | 0.19 | g/m2 | 0 | 0 | 0 | 0 | |
| 71 | | | | 0.25 | 0 | 1 | 70 | |
| 72 | | | | 0.5 | 0 | 1 | 75 | |
| 73 | | | | 1 | 0 | 1 | 85 | |
| 74 | | 0.38 | g/m2 | 0 | 0 | 0 | 0 | |
| 75 | | | | 0.25 | 0 | 1 | 75 | |
| 76 | | | | 0.5 | 0 | 1 | 80 | |
| 77 | | | | 1 | 0 | 1 | 90 | |
| 78 | Primacor | 0.78 | g/m2 | 0 | 0 | 0 | 75 | |
| 79 | 5990I (DOW) + | 1.57 | g/m2 | 0 | 0 | 0 | 75 | |
| | Silica 2 | | | | | | | |
| | (20% w/w of | | | | | | | |
| | polymer) | | | | | | | |
| 80 | Primacor | 0.78 | g/m2 | 0 | 0 | 0 | 75 | |
| 81 | 5990I (DOW) + | 1.56 | g/m2 | 0 | 0 | 0 | 80 | |
| | Fumed | | | | | | | |
| | Silica 1 | | | | | | | |
| | (6.3% w/w of | | | | | | | |
| | polymer) | | | | | | | |
| 82 | Primacor | 0.78 | g/m2 | 0 | 0 | 0 | 50 | |
| 83 | 5990I (DOW) + | 1.56 | g/m2 | 0 | 0 | 0 | 85 | |
| | Fumed | | | | | | | |
| | Silica 1 | | | | | | | |
| | (6.3% w/w of | | | | | | | |
| | polymer) + | | | | | | | |
| | Silica 2 | | | | | | | |
| | (20% w/w of | | | | | | | |
| | polymer) | | | | | | | |
| 84 | Primacor | 0.16 | g/m2 | 4 | 0 | 1 | 100 | |
| 85 | 5990I (DOW) + | 0.31 | g/m2 | 4 | 0 | 1 | 100 | |
| 86 | Silica 2 | 0.47 | g/m2 | 4 | 0 | 1 | 100 | |
| 87 | (20% w/w of | 0.63 | g/m2 | 4 | 0 | 1 | 100 | |
| 88 | polymer) | 0.78 | g/m2 | 4 | 0 | 1 | 100 | |
| 89 | | 1.57 | g/m2 | 4 | 0 | 1 | 100 | |
| 90 | Primacor | 0.16 | g/m2 | 4 | 0 | 1 | 100 | |
| 91 | 5990I + | 0.32 | g/m2 | 4 | 0 | 1 | 100 | |
| 92 | Fumed Silica 1 | 0.47 | g/m2 | 4 | 0 | 1 | 100 | |
| 93 | (6.3% w/w of | 0.63 | g/m2 | 4 | 0 | 1 | 100 | |
| 94 | polymer) | 0.78 | g/m2 | 4 | 0 | 1 | 100 | |
| 95 | | 1.56 | g/m2 | 4 | 0 | 1 | 100 | |
| 96 | Primacor | 0.16 | g/m2 | 4 | 0 | 1 | 100 | |
| 97 | 5990I (DOW) + | 0.31 | g/m2 | 4 | 0 | 1 | 100 | |
| 98 | Fumed Silica 1 | 0.47 | g/m2 | 4 | 0 | 1 | 100 | |
| 99 | (6.3% w/w of | 0.63 | g/m2 | 4 | 0 | 1 | 100 | |
| 100 | polymer) + | 0.78 | g/m2 | 4 | 0 | 1 | 100 | |
| 101 | Silica 2 | 1.56 | g/m2 | 4 | 0 | 1 | 100 | |
| | (20% w/w of | | | | | | | |
| | polymer) | | | | | | | |
| 102 | Chitosan | 0.038 | g/m2 | 0 | 0 | 0 | 0 | |
| 103 | | | | 0.25 | 0 | 1 | 65 | |
| 104 | | | | 0.5 | 0 | 1 | 70 | |
| 105 | | | | 1 | 0 | 1 | 85 | |
| 106 | | 0.076 | g/m2 | 0 | 0 | 0 | 0 | |
| 107 | | | | 0.25 | 0 | 1 | 65 | |
| 108 | | | | 0.5 | 0 | 1 | 75 | |
| 109 | | | | 1 | 0 | 1 | 90 | |
| 110 | | 0.3 | g/m2 | 0 | 0 | 0 | 0 | |
| 111 | | | | 0.25 | 0 | 1 | 75 | |
| 112 | | | | 0.5 | 0 | 1 | 90 | |
| 113 | | | | 1 | 0 | 1 | 90 | |
| 114 | Xanthan gum | 0.033 | g/m2 | 0 | 0 | 0 | 0 | |
| 115 | | | | 0.25 | 0 | 1 | 75 | |
| 116 | | | | 0.5 | 0 | 1 | 80 | |
| 117 | | | | 1 | 0 | 1 | 90 | |
| 118 | Sodium | 0.068 | g/m2 | 0 | 0 | 0 | 0 | |
| 119 | Alginate | | | 0.25 | 0 | 1 | 70 | |
| 120 | | | | 0.5 | 0 | 1 | 80 | |
| 121 | | | | 1 | 0 | 1 | 90 | |
| 122 | Sodium | 0.59 | g/m2 | 0 | 0 | 0 | 60 | |
| 123 | Alginate + | | | 0.25 | 0 | 1 | 80 | |
| 124 | Primacor | | | 0.5 | 0 | 1 | 85 | |
| 125 | 5990I | | | 1 | 0 | 1 | 95 | |
| 126 | Xanthan Gum + | 0.57 | g/m2 | 0 | 0 | 0 | 50 | |
| 127 | Primacor | | | 0.25 | 0 | 1 | 80 | |
| 128 | 5990I | | | 0.5 | 0 | 1 | 85 | |
| 129 | | | | 1 | 0 | 1 | 95 | |

### Examples 130 to 166 and Comparative Examples (CE) 8 to 17

The process described above is carried out using polyester fabrics and materials listed in Table 2 and where indicated the spray test performance was determined on the resulting treated fabric before and after being subject to washing.

TABLE 2
Samples prepared according to process B, using polyester fabrics.

| | | | | | | | | Spray test |
|---|---|---|---|---|---|---|---|---|
| | | Micro | | HeiQ | HeiQ | HeiQ | | performance |
| | | Fibres | | Barrier | Barrier | Effect | | after washing |
| | Micro Fibre | deposited | | ECO | HM-C6 | SAX | Spray test | (# of heavy |
| | material | (g/(m of | | concentration | concentration | concentration | performance | load washes in |
| EX. | deposited | fabric)²) | | (vol. %) | (vol. %) | (vol. %) | as made | brackets) |
| CE8 | None | 0 | | 0 | 3 | 0.06 | 100 | 100 (10) |
| CE9 | | | | 0 | 2 | 0.06 | 100 | 100 (10) |
| CE10 | | | | 0 | 1 | 0.06 | 100 | 95 (10) |
| CE11 | | | | 0 | 0.5 | 0.06 | 100 | 90 (10) |
| CE12 | | | | 0 | 0.25 | 0.06 | 85 | 85 (10) |
| CE13 | | | | 3 | 0 | 1 | 100 | 90 (10) |
| CE14 | | | | 2 | 0 | 1 | 100 | 85 (10) |
| CE15 | | | | 1 | 0 | 1 | 95 | 75 (10) |
| CE16 | | | | 0.5 | 0 | 1 | 70 | 70 (10) |
| CE17 | | | | 0.25 | 0 | 1 | 50 | 70 (10) |
| 130 | Primacor | 1.58 | g/m2 | 3 | 0 | 1 | 100 | 90 (10) |
| 131 | 5990I | | | 2 | 0 | 1 | 100 | 85 (10) |
| 132 | | | | 1 | 0 | 1 | 100 | 85 (10) |
| 133 | | | | 0.5 | 0 | 1 | 95 | 80 (10) |
| 134 | | | | 0.25 | 0 | 1 | 90 | 75 (10) |
| 135 | | | | 0 | 0 | 0 | 50 | 50 (10) |
| 136 | Primacor | 1.58 | g/m2 | 0 | 3 | 0.06 | 100 | 100 (10) |
| 137 | 5990I | | | 0 | 2 | 0.06 | 100 | 100 (10) |
| 138 | | | | 0 | 1 | 0.06 | 100 | 100 (10) |
| 139 | | | | 0 | 0.5 | 0.06 | 100 | 95 (10) |
| 140 | | | | 0 | 0.25 | 0.06 | 100 | 95 (10) |
| 141 | Primacor | 0.8 | g/m2 | 3 | 0 | 1 | 95 | 85 (10) |
| 142 | 5990I + silk | | | 2 | 0 | 1 | 90 | 85 (10) |
| 143 | fibroin | | | 1 | 0 | 1 | 90 | 75 (10) |
| 144 | (30% wt) | | | 0.5 | 0 | 1 | 80 | 75 (10) |
| 145 | | | | 0.25 | 0 | 1 | 60 | 70 (10) |
| 146 | | 0.8 | g/m2 | 0 | 0 | 0 | 0 | 50 (10) |
| 147 | Primacor | 0.8 | g/m2 | 0 | 3 | 0.06 | 100 | 95 |
| 148 | 5990I + silk | | | 0 | 2 | 0.06 | 100 | 90 |
| 149 | fibroin | | | 0 | 1 | 0.06 | 95 | 90 |
| 150 | (30% wt) | | | 0 | 0.5 | 0.06 | 95 | 85 |
| 151 | | | | 0 | 0.25 | 0.06 | 80 | 80 |
| 152 | Primacor | 1 | g/m2 | 2 | 0 | 1 | 100 | 100 (3) |
| 153 | 5990I (32% w) − | | | 1 | 0 | 1 | 95 | 90 (3) |
| 154 | Fixamin NL | | | 0.5 | 0 | 1 | 90 | 85 (3) |
| 155 | M06 (68% w) | | | 0.25 | 0 | 1 | 75 | 80 (3) |
| 156 | (NL:PEAA = | | | 0 | 0 | 1 | 70 | 50 (3) |
| | 1:4v) | | | | | | | |
| 157 | Primacor | 0.8 | g/m2 | 2 | 0 | 1 | 100 | 95 (3) |
| 158 | 5990I | | | 1 | 0 | 1 | 95 | 90 (3) |
| 159 | (74.6% w) − | | | 0.5 | 0 | 1 | 90 | 80 (3) |
| 160 | Fixamin NL | | | 0.25 | 0 | 1 | 75 | 75 (3) |
| 161 | M06 (25.4% w) | | | 0 | 0 | 0 | 50 | |
| | (NL:PEAA = | | | | | | | |
| | 1:8v) | | | | | | | |
| 162 | Fixamin NL | 2 | g/m2 | 2 | 0 | 1 | 100 | 95 (3) |
| 163 | M06 | | | 1 | 0 | 1 | 95 | 90 (3) |
| 164 | | | | 0.5 | 0 | 1 | 80 | 80 (3) |
| 165 | | | | 0.25 | 0 | 1 | 75 | 75 (3) |
| 166 | | | | 0 | 0 | 0 | 0 | |

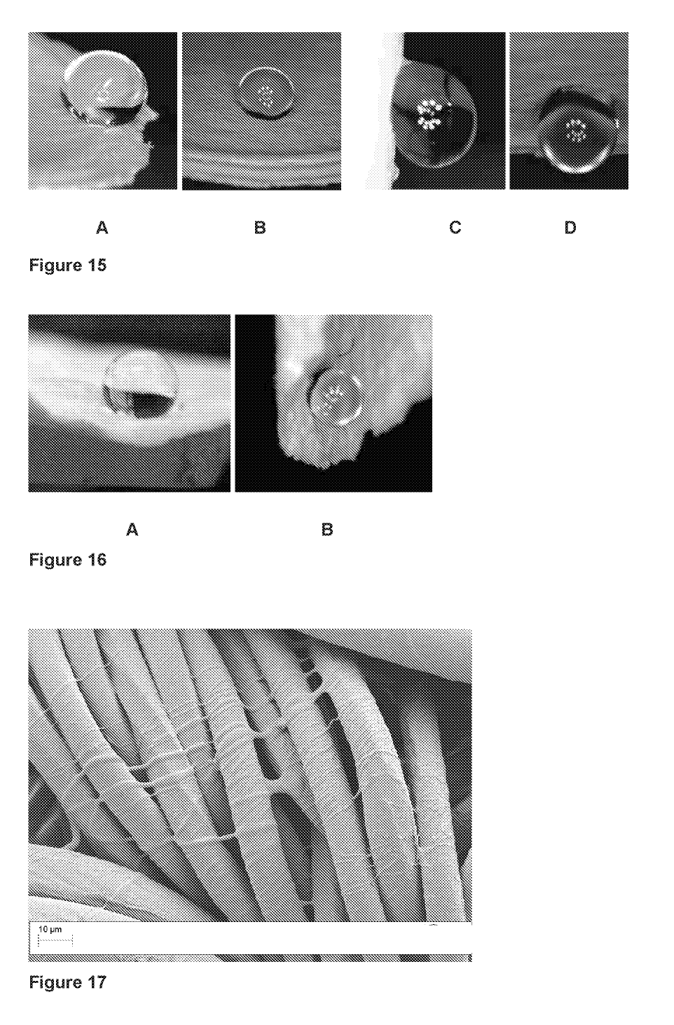

The desired angle of retention for a 5 microliters water droplet is at least 90° (preferably at least 110°, preferably 180°) for highly-hydrophobic sticky samples. FIGS. 15 and 16 shows examples of highly hydrophobic sticky fabrics, prepared according to this process.

The process may result in an improved performance of the treated fibrous substrates in such a manner that the performance of an ECO/SAX treated sample can be improved to the performance expected for HM-C6/SAX treatment of the same sample, but in the absence of microfibres. FIG. 4, Comparative Example CE1, and Examples 6, 89, 95, 101.

Typical fibre dimensions may depend on the materials used to produce the microfibres. Microfibre dimensions typical of Primacor fibres are in the range 0.4-3 μm for the diameter and 20-100 μm for the length.

The microfibre dimensions typical of silk-Primacor fibres are in the range 0.2-1 μm for the diameter and 10-100 μm for the length.

The microfibre dimensions typical of alginate fibres are in the range 0.02-1 μm for the diameter and 10-100 μm for the length.

### Examples 167 to 175 and Comparative Examples (CE) 18 to 24

The process described above is carried out using a polyamide-elastane fabric and materials listed in the Table 3 and where indicated the spray test performance was determined on the resulting treated fabric.

TABLE 3
Samples prepared according to process A, using polyamide-elastane fabrics.

| | | | | | | | Spray test |
|---|---|---|---|---|---|---|---|
| | | | HeiQ | HeiQ | HeiQ | | performance |
| | | Micro | Barrier | Barrier | Effect | | after washing |
| | Micro Fibre | Fibres | ECO | HM-C6 | SAX | Spray test | (# of heavy |
| | material | in bath | concentration | concentration | concentration | performance | load washes in |
| EX. | deposited | (% w/v) | (vol. %) | (vol. %) | (vol. %) | as made | brackets) |
| CE18 | None | 0 | 0 | 3 | 0.06 | 100 | 90 |
| CE19 | | 0 | 0 | 2 | 0.06 | 100 | 85 |
| CE20 | | 0 | 0 | 1 | 0.06 | 100 | 90 |
| CE21 | | 0 | 0 | 7.6 | 0.06 | 100 | |
| CE22 | | 0 | 0 | 0 | 0 | 0 | |
| 167 | Primacor 5990I | 1.37 | 0 | 0 | 0 | 50 | |
| 168 | Primacor 5990I | 0.5 | 0 | 0 | 0 | 50 | |
| 169 | Primacor 5990I | 0.13 | 0 | 7.6 | 0.06 | 100 | |
| | (then coated with | | | | | | |
| | HM-C6/SAX) | | | | | | |
| 170 | Primacor 5990I | 0.13 | 0 | 7.6 | 0.06 | 100 | |
| | (mixed with HM- | | | | | | |
| | C6/SAX) | | | | | | |
| 171 | Primacor 5990I | 0.13 | 0 | 7.6 | 0.06 | 100 | |
| | (HM-C6/SAX - | | | | | | |
| | then coated with | | | | | | |
| | fibres) | | | | | | |
| 172 | Primacor 5990I | 0.26 | 0 | 7.6 | 0.06 | 100 | |
| | (HM-C6/SAX - | | | | | | |
| | then coated with | | | | | | |
| | fibres) | | | | | | |
| 173 | Primacor 5990I | 0.26 | 0 | 7.6 | 0.06 | 100 | |
| | (then coated with | | | | | | |
| | HM-C6/SAX) | | | | | | |
| 174 | Primacor 5990I | 0.26 | 6 | 0 | 1 | 100 | |
| | (then coated with | | | | | | |
| | ECO/SAX) | | | | | | |
| 175 | Primacor 5990I | 0.26 | 6 | 0 | 1 | 100 | |
| CE23 | None | 0 | 6 | 0 | 1 | 100 | |
| CE24 | None | 0 | 0 | 0 | 0 | 0 | |

### Examples 176 to 179 and Comparative Examples (CE) 25 and 26

The process described above is carried out using a leather substrate and materials listed in Table 4.

TABLE 4
Leather samples, coated according to Process C.

| | Micro Fibre | Micro | | | |
|---|---|---|---|---|---|
| | material | Fibres | Coating rate | Solvent | Thermal |
| EX. | deposited | In spray | and passes | of spray | treatment |
| CE25 | None | 0 | 100 ml/min - 2 | 1-butanol | Air dry |
| | | | passes | | |
| CE26 | None | 0 | 100 ml/min - 2 | 1-butanol | 80° C. for |
| | | | passes | | 2 min |
| 176 | Primacor | 0.2% w/v | ~10 ml/min - 7 | 1-butanol | Air dry |
| | 5990I | | passes (1 min) | | |
| 177 | Primacor | 0.2% w/v | ~10 ml/min - 7 | 1-butanol | 80° C. for |
| | 5990I | | passes (1 min) | | 2 min |
| 178 | Primacor | 0.2% w/v | ~10 ml/min - 7 | 1-butanol | Air dry |
| | 5990I | | passes (1 min) | | |
| 179 | Primacor | 0.2% w/v | ~10 ml/min - 7 | 1-butanol | 80° C. for |
| | 5990I | | passes (1 min) | | 2 min |

TABLE 5
Polyamide-elastane fabric coated according to
Process B, in the absence of heat treatment.

| | | | Water | | |
|---|---|---|---|---|---|
| | | Micro | contact | Roll off | |
| | | Fibres | angle of | angle for 5 | Measured |
| | Micro Fibre | deposited | fibre- | microliters | water |
| | material | (g/(m of | forming | deionised | contact |
| EX. | deposited | fabric)²) | material | water drop | angle |
| 180 | Primacor 5990I | 3.9 | 88° ± 3° | No roll off | 150° ± 4° |
| | Silk fibroin | | | | |
| | (50% wt) | | | | |
| 181 | Primacor 5990I | 4.5 | 75° ± 7° | No roll off | 120°-140° |
| 182 | Primacor 5990I | 4.0 | 87° ± 4° | No roll off | 95° ± 4° |
| | Silk fibroin | | | | |
| | (30% wt) | | | | |

The results of Examples 180 and 181 are depicted in FIGS. 15 and 16 respectively.

Drag Testing Description and Results

Swimwear is an example of a fabric use that requires not only durable water repellency but in competitive swimwear scenarios it would be advantageous to additionally achieve improved drag properties. Reducing the coefficient of drag for a fabric with a surface treatment may reasonably be expected to play a role in reducing the level of hydrodynamic drag across the fabric during swimming conditions.

The influence of various surface treatments upon surface drag coefficient was examined using a hydrodynamic drag force testing apparatus. The testing principle involved fixing a single fabric test piece (7 cm×22 cm) around the surface of a hydrofoil of defined shape profile (symmetrical NACA 15 airfoil profile). The hydrofoil body with affixed fabric was then immersed in a channel of water flowing at a controlled velocity (varied between 0.3 and 0.5 m/s). A digital force sensor connected to the hydrofoil via a thin gauge nylon filament enabled quantitative measurement of drag force and also served to anchor the hydrofoil suspended within the flowing water. For each test fabric the steady state force was recorded and subsequently resolved into body (pressure) drag and surface (friction) drag components using established theory and assuming a body drag coefficient of 0.04 for a streamlined hydrofoil profile. The characteristic surface drag coefficient (at 0.5 m/s) was then determined for each fabric sample and compared to assess the relative drag potential of the treatments.

The fabric type considered during the testing was a stretch woven fabric composed of a polyamide and elastane blend that is typical for swimwear fabrics. The fabric was treated with various aqueous formulations using a lab padder and a lab stenter (drying for 2 mins at 120° C., and curing for 3 minutes at 150° C.). The various treatments involved fluorine-based (HeiQ Barrier HM-C6) and fluorine-free (HeiQ Barrier ECO) water repellency products used alone as conventional treatments (with HeiQ Effect SAX as cross-linker) or additionally in combination with Primacor short fibre materials. Treatments with Primacor short fibres alone in the absence of water repellency components were also tested. The treated fabrics were tested in the drag apparatus described previously and were also examined using the AATCC 22 spray test for water repellency performance.

The results indicate that the Primacor fibres when applied to the fabric in absence of the repellency treatment already provide a favorable influence on reducing the drag coefficient of the fabric. When used in combination with either fluorine-free (Barrier ECO) or fluorine-based (Barrier HM-C6) repellency treatments the Primacor fibres provide further improvement in drag coefficients compared to the repellency treatments alone. The results indicate that the Primacor short fibres may impart favorable drag reduction properties to the fabric substrate.

TABLE 6
Comparison of surface drag coefficient and spray test rating for various fabric treatments.

| | | | | | | | | Drag |
|---|---|---|---|---|---|---|---|---|
| | | | | | | | | coefficient |
| | | Treatment | | | | Spray | Surface | reduction |
| | | Barrier | Barrier | Effect | | Test | drag | relative to |
| | | ECO | HM-C6 | SAX | Primacor | AATCC 22 | coefficient | untreated |
| Series | Sample | (% wt) | (% wt) | (% wt) | fibres | (/100) | @0.5 m/s | reference |
| A-1 | Reference | — | — | — | — | — | 0.482 | — |
| | (untreated) (CE 22) | | | | | | | |
| A-2 | Primacor 5990I | — | — | — | 0.26% | 50 | 0.452 | 6.2% |
| | fibres only (Ex. 167) | | | | | | | |
| A-3 | ECO only (CE21) | 6% | — | 1% | | 100 | 0.450 | 6.7% |
| A-4 | ECO + Primacor | 6% | — | 1% | 0.26% | 100 | 0.445 | 7.8% |
| | 5990I fibres (Ex. 175) | | | | | | | |
| B-1 | Reference | — | — | — | — | — | 0.483 | — |
| | (untreated) (CE24) | | | | | | | |
| B-2 | Primacor 5990I | — | — | — | 0.5% | 50 | 0.450 | 6.9% |
| | fibres only (Ex. 168) | | | | | | | |
| B-3 | HM-C6 only (CE 23) | — | 7.6% | 0.06% | | 100 | 0.437 | 9.5% |
| B-4 | HM-C6 + Primacor | — | 7.6% | 0.06% | 0.5% | 100 | 0.434 | 10.2% |
| | 5990I fibres (Ex 170) | | | | | | | |

TABLE 7
Comparison of spray test performance for various
fabric treatments using Primacor 5990I (PEAA).
Comparative examples CE1-6, Examples 1-15.

| | Before | 3 Washes - | 10 Washes - |
|---|---|---|---|
| Controls | Wash | Heat Dried | Heat Dried |
| PEAA fibers 0.48 g/m² | 0 | 50 | 50 |
| PEAA fibers 1.58 g/m² | 60 | 60 | 60 |
| ECO/SAX Only (vol %) | ECO/SAX alone, no fibers | | |
| 4 | 95 | 100 | 95 |
| 3 | 95 | 100 | 95 |
| 2 | 95 | 100 | 95 |
| 1 | 95 | 90 | 85 |
| 0.5 | 70 | 70 | 80 |
| 0.25 | 50 | 65 | 75 |
| ECO/SAX (vol %)+ | 0.48 g/m² PEAA | | |
| 4 | 100 | 100 | 100 |
| 3 | 100 | 100 | 95 |
| 2 | 100 | 100 | 95 |
| 1 | 95 | 90 | 90 |
| 0.5 | 80 | 85 | 85 |
| 0.25 | 60 | 70 | 75 |
| ECO/SAX (vol %)+ | 1.58 g/m² PEAA | | |
| 4 | 100 | 100 | 100 |
| 3 | 100 | 100 | 100 |
| 2 | 100 | 100 | 95 |
| 1 | 100 | 90 | 95 |
| 0.5 | 95 | 90 | 90 |
| 0.25 | 60 | 70 | 80 |

TABLE 8
Comparison of spray test performance for various
fabric treatments using Primacor 5990I (PEAA).
Examples 30-33, 35-38, 40-43, 45-48.

| Fibers that retain | | |
|---|---|---|
| morphology upon | | 3 Washes - |
| thermal treatment | Before wash | Heat Dried |
| ECO/SAX(vol %)+ | Low PUK-PEAA - CaCl2 crosslinked | |
| 2 | 95 | 95 |
| 1 | 90 | 85 |
| 0.5 | 75 | 75 |
| 0.25 | 75 | 75 |
| ECO/SAX (vol %)+ | medium PUK-PEAA - CaCl2 crosslinked | |
| 2 | 100 | 95 |
| 1 | 90 | 85 |
| 0.5 | 85 | 80 |
| 0.25 | 75 | 75 |
| ECO/SAX (vol %)+ | Medium high PUK-PEAA - CaCl2 crosslinked | |
| 2 | 100 | 100 |
| 1 | 95 | 90 |
| 0.5 | 85 | 80 |
| 0.25 | 80 | 75 |
| ECO/SAX (vol %)+ | High PUK-PEAA - CaCl2 crosslinked | |
| 2 | 100 | 100 |
| 1 | 90 | 90 |
| 0.5 | 85 | 80 |
| 0.25 | 80 | 80 |

1. A process for providing a water repellent substrate comprising:
providing a dispersion in a liquid of discrete-length microfibers comprising a material adapted to be fluid under the processing conditions to be used;
applying the dispersion to the substrate;
optionally removing liquid from the microfibers and substrate or allowing the liquid to dry; and
subjecting the microfibers to processing conditions under which the material is at least partly fluid, such that the microfibers deform to provide adhesion of microfibers with other microfibers, adhesion of the microfibers with the substrate or a mixture of adhesion with other microfibers and with the substrate.

2. A process according to claim 1 wherein the process conditions under which the material is at least partly fluid are selected from the group consisting of softening the material with a solvent, heating the microfibers to a temperature above the softening point of the material and a combination thereof.

3. A process according to claim 1, wherein the substrate is fibrous.

4. A process according to claim 1, wherein the substrate selected from the group consisting of fabric, leather, paper and cardboard.

5. A process according to claim 1, wherein the material adapted to be fluid under the processing conditions has a softening point of no more than 160° C. and the processing conditions comprise subjecting the microfibers to a temperature of from 110° C. to 180° C.

6. A process according to claim 1, wherein the dispersion is an aqueous dispersion.

7. (canceled)

8. A process according to claim 1, wherein the microfiber material adapted to be fluid comprises a compound selected from the group consisting of polymeric materials, waxes and inorganic materials.

9. A process according to claim 1, wherein the microfiber material adapted to be fluid is selected from the group consisting of polyesters, epoxides, nitrile rubbers, latex rubbers, polyurethanes, polyvinyl s, polyacrylates, melamine and phenolic resins, polyolefins, polyacids, olefin copolymers and mixtures thereof.

10. A process according to claim 1, wherein the microfiber material adapted to be fluid has a melting point of from 50° C. to 160° C.

11. (canceled)

12. (canceled)

13. A process according to claim 1, wherein the material adapted to be fluid comprises a polymer of acrylic acid.

14. A process according to claim 1, wherein the material adapted to be fluid comprises a copolymer of acrylic acid and a comonomer comprising at least one selected from olefins, urethanes, acrylates and vinyls.

15. (canceled)

16. A process according to claim 14, wherein the material comprise a copolymer of ethylene and acrylic acid preferably comprising from 1% to 20% acrylic acid.

17. (canceled)

18. A process according to claim 13, wherein the material adapted to be fluid comprises a blend of an acrylic acid polymer and a further material selected from the group consisting of polymers, inorganic particulate fillers and waxes.

19. (canceled)

20. A process according to claim 1, wherein the microfiber dispersion is applied as a spray to the substrate surface.

21. A process according to claim 1, wherein the microfiber dispersion is applied at a rate of from 0.01 g to 50 g of microfiber per square metre of fabric.

22. (canceled)

23. (canceled)

24. A process according to claim 1, wherein the microfibers have an aspect ratio of at least 10.

25. A process according to claim 1, wherein the microfibers are of dimension in the range of from 5 to 1000 microns length and from 0.01 to 5 microns thickness.

26. (canceled)

27. A process according to claim 1, wherein the dispersion further comprises a dispersed water repellent, selected from fluorinated and non-fluorinated water repellent agents.

28. (canceled)

29. A process according to claim 1, wherein the resulting water repellent substrate is a fabric having a contact angle of at least 130°.

30. A process according to claim 29 wherein the substrate has a contact angle of no more than 100° prior to the process.
